(19) United States
(12) Patent Application Publication
(10) Pub. No.: US 2026/0221029 A1
(43) Pub. Date: Jul. 30, 2026

(54) VIRTUAL VAPOR TRAIL ALERTS ABOUT SLOW-MOVING VEHICLES

(71) Applicant: Avago Technologies International Sales Pte. Limited, Singapore (SG)

(72) Inventors: Roger A. Fratti, Mohnton, PA (US); Shawn Shiliang Ding, San Diego, CA (US)

(21) Appl. No.: 19/038,561

(22) Filed: Jan. 27, 2025

(51) Int. Cl. G08G 1/0967; G08G 1/052

(52) U.S. Cl. CPC G08G 1/0967; G08G 1/052

(57) ABSTRACT

A traffic monitor is configured to alert a second vehicle about a first vehicle in front of the second vehicle, by performing the steps of: broadcasting a first request for speed information as a first Bluetooth Low Energy (BLE) signal, the first request including a universally unique identifier (UUID) associated with BLE, and then receiving a first response from the first vehicle in response to the first request, the first response containing data that indicates that the first vehicle is moving at a first speed; comparing the first speed to a threshold speed to determine that the first speed is less than the threshold speed, and determining, based on the first speed, a first time period for alerting other vehicles about the first vehicle; and alerting the second vehicle during the first time period about the first vehicle in response to the first speed being less than the threshold speed.

### BACKGROUND

Slow-moving vehicles on roads present a significant danger of being rear-ended by faster-moving traffic. For example, there has been a surge in electric vehicles that are limited in speed, including electric mopeds, electric scooters, and electric bicycles (e-bikes), which often cannot move as fast as other vehicles. The risks of collisions occurring is especially high where visibility is impaired such as where there is a corner or bend in the road and the direction of the road changes dramatically. There is thus increasingly a need for a system for reducing the risks of slow-moving vehicles being rear-ended.

### SUMMARY

One or more embodiments provide a traffic monitor including a processor and memory, wherein the processor executes instructions stored in the memory to alert a second vehicle about a first vehicle in front of the second vehicle. By executing such instructions, the traffic monitor performs the steps of: broadcasting a first request for speed information as a first Bluetooth Low Energy (BLE) signal, the first request including a universally unique identifier (UUID) associated with BLE and associated with a service of the traffic monitor, and then receiving a first response from the first vehicle in response to the first request, the first response containing data that indicates that the first vehicle is moving at a first speed; comparing the first speed to a threshold speed to determine that the first speed is less than the threshold speed, and determining, based on the first speed, a first time period for alerting other vehicles about the first vehicle; and alerting the second vehicle during the first time period about the first vehicle in response to the first speed being less than the threshold speed.

Further embodiments include a method comprising the above steps and a non-transitory computer-readable storage medium comprising instructions that cause a traffic monitor to carry out the above steps.

### BRIEF DESCRIPTION OF THE DRAWINGS

FIG. 1 is a block diagram of a system in which embodiments may be implemented.

FIG. 2 is a flow diagram of a method that may be performed by a traffic monitor and a vehicle for the traffic monitor to obtain information for reducing risks of collisions, according to some embodiments.

FIG. 3 is a flow diagram of a method that may be performed by the traffic monitor to analyze information to be used for reducing risks of collisions and to alert vehicles about a slow-moving vehicle throughout a time period, according to some embodiments.

FIG. 4 is a flow diagram of a method that may be performed by the traffic monitor to alert target vehicles about slow-moving vehicles ahead based on information about the target vehicles and the slow-moving vehicles, according to some embodiments.

### DETAILED DESCRIPTION

Techniques are described for reducing the risks of slow-moving vehicles being rear-ended. As used herein, a “slow-moving vehicle” is a vehicle that is moving at a speed that creates an elevated risk of being rear-ended, e.g., moving more than a predetermined speed under a posted speed limit. The techniques herein involve implementing a device on the side of a road that communicates with vehicles as they pass by. Such device is referred to herein as a “traffic monitor.”

The traffic monitor broadcasts requests for speed information, which the vehicles may detect as they pass by the traffic monitor. To “broadcast” such requests means to send the requests to other devices without establishing direct connections with those devices. When a vehicle detects such a request, the vehicle may transmit a response to the traffic monitor, including data that indicates a speed that the vehicle is moving at. If the vehicle is a slow-moving vehicle, the traffic monitor may store information about the slow-moving vehicle such as its speed and direction.

Additionally, if the vehicle is a slow-moving vehicle, the traffic monitor determine a time period for alerting other vehicles about the slow-moving vehicle. For example, the traffic monitor may cause a nearby display device on the side of the road to post text throughout the determined time period indicating that there is a slow-moving vehicle ahead. Such alert may act as a “virtual vapor trail” behind the slow-moving vehicle by serving as a cue about the slow-moving vehicle's whereabouts. Alternatively, during the determined time period, the traffic monitor may determine whether to alert vehicles passing by the traffic monitor based on information provided by the other vehicles. For example, the traffic monitor may decide whether there is a sufficient risk of other vehicles rear-ending the slow-moving vehicle based on such information. If so, the traffic monitor may alert such other vehicles, e.g., using the nearby display device as those vehicles pass by.

Embodiments reduce the risks of slow-moving vehicles being rear-ended by providing advanced warning to others about risks in their immediate vicinity. Such advanced warning may be necessary for preventing collisions. This may especially be the case when visibility is impaired and a person in a faster-moving vehicle will have limited time to react once a slow-moving vehicle is within view. Additionally, embodiments are able to optimize such warnings in various ways.

For example, the vehicles may transmit accurate speeds to the traffic monitor, which may be measured by the vehicles themselves, e.g., based on rotational speeds of wheels as measured by wheel speed sensors. Such speeds may be more accurate than line-of-sight speeds, which are often determined by third parties relying on technologies such as light detection and ranging (LiDAR). By basing decisions on highly accurate speeds, the traffic monitor may accurately determine when a vehicle is moving sufficiently slow to warrant warning other vehicles. This may reduce instances in which an alert is posted unnecessarily or instances in which an alert is not posted despite there actually being a high risk of collision. Furthermore, the traffic monitor may accurately determine when there is a sufficiently high risk of a slow-moving vehicle being rear-ended (to warrant posting an alert).

As another example, the traffic monitor may determine the directions that vehicles are traveling at based on the responses from the vehicles. The traffic monitor may use such direction information to more accurately determine when there is a high risk of collision, e.g., when a faster-moving vehicle is moving in the same direction as a slow-moving vehicle in front of it. As another example, the traffic monitor may determine the distance between a slow-moving vehicle and a faster-moving vehicle behind it, based on information from the responses from the two vehicles. The traffic monitor may use such distance information to more accurately determine when there is a high risk of collision, e.g., posting an alert when the distance is sufficiently small or determining not to post an alert when the distance is sufficiently large. These and further aspects of the invention are discussed below with respect to the drawings.

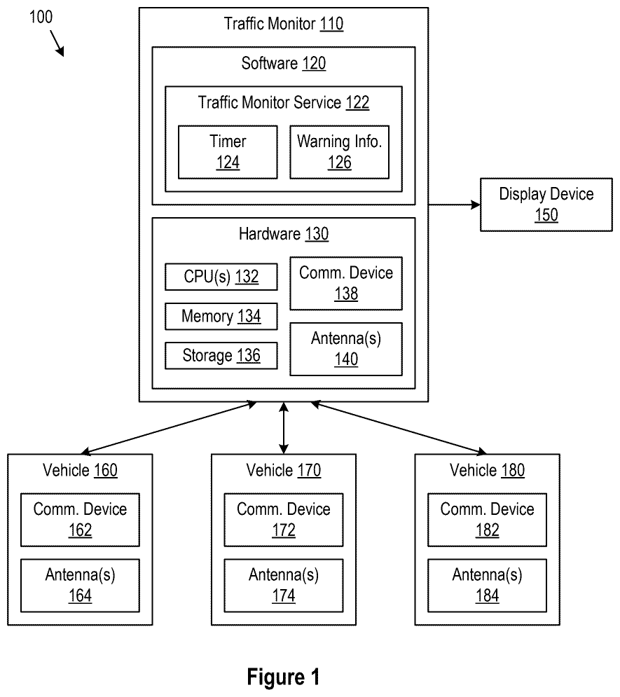

FIG. 1 is a block diagram of a system 100 in which embodiments may be implemented. System 100 includes a traffic monitor 110, a display device 150, and a plurality of vehicles, including a vehicle 160, a vehicle 170, and a vehicle 180. Vehicles 160, 170, and 180 pass by traffic monitor 110 and communicate with traffic monitor 110 as they pass by. Specifically, vehicles 160, 170, and 180 detect messages from traffic monitor 110 requesting speed information of the respective vehicles. Vehicles 160, 170, and 180 then transmit responses to traffic monitor 110 to be used by traffic monitor 110 for reducing the risks of slow-moving vehicles being rear-ended.

Traffic monitor 110 is an apparatus that is equipped with devices for communicating with vehicles, analyzing responses from vehicles, and alerting vehicles. For example, traffic monitor 110 may be a post that is oriented in a vertical direction, and may be powered, e.g., by a solar panel. Traffic monitor 110 includes hardware 130 such as one or more central processing units (CPUs) 132, memory 134 such as random-access memory (RAM), local storage 136 such as a magnetic drive or solid-state drive (SSD), a communication device 138, and one or more antennas 140. CPU(s) 132 are configured to execute instructions such as executable instructions that perform one or more operations described herein, which may be stored in memory 134.

Communication device 138 is a device that enables traffic monitor 110 to communicate with vehicles passing by such as vehicles 160, 170, and 180. For example, communication device 138 may be a network interface controller (NIC) including a Bluetooth® module for communicating over a Bluetooth Low Energy (BLE) mesh network. BLE is a wireless communication technology designed for short-range, low-power data transmission. For example, using BLE may offer advantages to traffic monitor 110 such as using less power for communication than other communication technologies may demand and providing lower-latency communications with vehicles than other communication technologies may support. Antenna(s) 140 is a device(s) configured to transmit and receive messages as electromagnetic waves, e.g., in the frequency range of BLE.

Hardware 130 supports software 120, including a traffic monitor service 122. Traffic monitor service 122 is software such as an application that is configured to perform one or more operations for reducing the risks of slow-moving vehicles being rear-ended. Traffic monitor service 122 may include a timer 124 and warning information 126, which may be stored, e.g., in memory 134. Timer 124 may indicate a time period for warning other vehicles about a slow-moving vehicle, an amount of time for the time period increasing as the speed of the slow-moving vehicle decreases. Warning information 126 includes information used by traffic monitor service 122 to make decisions such as whether to alert other vehicles about a slow-moving vehicle. For example, warning information 126 may include the speed and direction of a slow-moving vehicle.

Display device 150 is a device that is configured to display alerts to drivers. For example, display device 150 may include a light emitting diode (LED) display or liquid crystal display (LCD) screen. Display device 150 may be positioned, e.g., on the side of a road near traffic monitor 110 such that it is viewable at vehicles that recently passed by traffic monitor 110. Traffic monitor 110 may instruct display device 150 to display alerts by communicating with display device 150, e.g., using BLE.

Vehicles 160, 170, and 180 are machines designed for transporting people and/or goods. Examples of vehicles 160, 170, and 180 include automobiles such as internal combustion engine (ICE) vehicles, hybrids, electric vehicles (EVs), along with other types of vehicles such as electric mopeds, electric scooters, and e-bikes. Any of vehicles 160, 170, and 180 may be slow-moving vehicles. Although traffic monitor 110 is illustrated as communicating with 3 vehicles, traffic monitor 110 may, at any given time, simultaneously communicate with more than 3 vehicles or less than 3 vehicles.

Vehicles 160, 170, and 180 include communication devices 162, 172, and 182, respectively. Similar to communication device 138 of traffic monitor 110, communication devices 162, 172, and 182 are devices such as NICs including Bluetooth® modules, which enable respective vehicles to communicate with traffic monitor 110. Vehicles 160, 170, and 180 further include antennas 164, 174, and 184, respectively. Similar to antenna(s) 140 of traffic monitor 110, antennas 164, 174, and 184 are devices configured to transmit and receive messages as electromagnetic waves, e.g., in the frequency range of BLE.

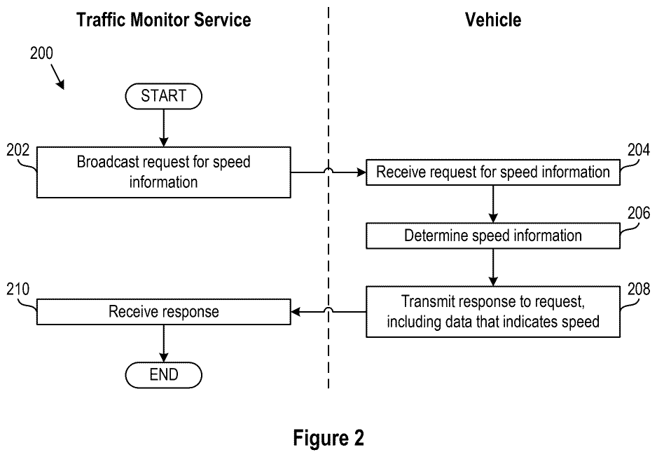

FIG. 2 is a flow diagram of a method 200 that may be performed by traffic monitor 110 and a vehicle for traffic monitor 110 to obtain information for reducing risks of collisions, according to some embodiments. Method 200 will be discussed with respect to vehicle 160 as an example. At step 202, traffic monitor service 122 broadcasts a request for speed information. For example, traffic monitor service 122 may broadcast such request at periodic intervals, e.g., every 30 milliseconds. For example, if traffic monitor service 122 uses BLE, traffic monitor service 122 may send “advertisement packets,” which are BLE signals including information such as an identifier (ID) of traffic monitor 110. The request for speed information may further include a universally unique identifier (UUID) associated with traffic monitor service 122. For example, if traffic monitor service 122 uses BLE, such UUID may be associated with BLE and may be assigned by the Bluetooth Special Interest Group (SIG).

At step 204, vehicle 160 receives the request for speed information. For example, vehicle 160 may extract a UUID from the request for speed information to determine what is requested by traffic monitor service 122. At step 206, vehicle 160 may determine speed information about itself. For example, vehicle 160 may determine a rotational speed of one of its wheels as measured by a wheel speed sensor.

At step 208, vehicle 160 transmits, to traffic monitor service 122, a response to the request for speed information. Vehicle 160 includes, in the response, data indicating the speed of vehicle 160. For example, vehicle 160 may include the rotational speed of the one of its wheels along with other information for calculating the speed of vehicle 160 based on the rotational speed such as the radius or diameter of the wheel. As another example, vehicle 160 may calculate its speed itself (e.g., based on the rotational speed of the one of its wheels) and directly report the calculated speed in the response.

Vehicle 160 may further include additional information in the response. For example, vehicle 160 may include a transmit signal strength indicator (TSSI). TSSI is a metric that measures the strength of a signal being transmitted by a wireless device, e.g., by communication device 162 of vehicle 160. As another example, in the case of using BLE, vehicle 160 may include a constant tone extension (CTE) tone. A CTE tone is a constant tone added to the transmission of Bluetooth® packets to extend such transmission and allow for receivers such as traffic monitor service 122 to precisely calculate the direction that such transmission originates from.

At step 210, traffic monitor service 122 receives the response from vehicle 160. For example, if traffic monitor 110 only includes a single antenna 140, traffic monitor 110 detects the response at the antenna. As another example, if traffic monitor 110 includes a plurality of antennas 140, traffic monitor 140 may detect the response at each of antennas 140. After step 210, method 200 ends.

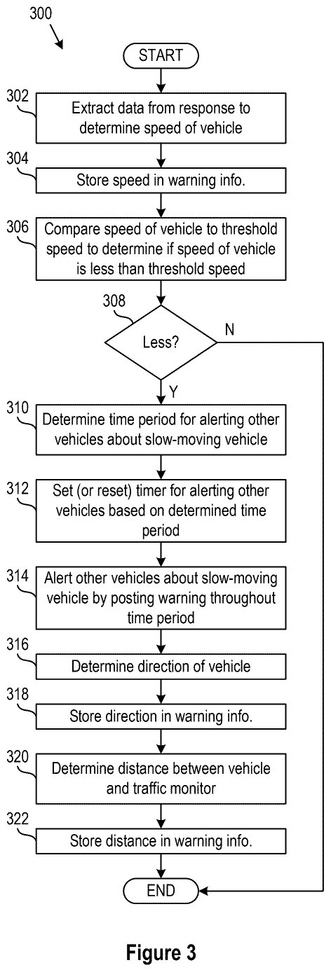

FIG. 3 is a flow diagram of a method 300 that may be performed by traffic monitor 110 to analyze information to be used for reducing risks of collisions and to alert vehicles about a slow-moving vehicle throughout a time period, according to some embodiments. Method 300 may be performed by traffic monitor 110 each time it receives a response from a vehicle according to method 200. Method 300 will be discussed with respect to vehicle 160 as an example. At step 302, traffic monitor service 122 extracts data from the response to determine the speed of vehicle 160. For example, if the extracted data includes information for calculating the speed, traffic monitor service 122 may calculate the speed based on the extracted data. As another example, as mentioned above, the extracted data may simply include a speed calculated by vehicle 160.

At step 304, traffic monitor service 122 stores the speed of vehicle 160 in warning information 126. At step 306, traffic monitor service 122 compares the speed of vehicle 160 to a threshold speed to determine if the speed of vehicle 160 is less than the threshold speed. For example, the threshold speed may be set based on a posted speed limit, e.g., set to 10 miles per hour under the speed limit. At step 308, if the speed of vehicle 160 is not less than the threshold speed, method 300 ends, and traffic monitor service 122 determines not to warn other vehicles about vehicle 160. Otherwise, if the speed of vehicle 160 is less than the threshold speed, method 300 moves to step 310.

At step 310, traffic monitor service 122 determines a time period for alerting other vehicles about vehicle 160, which has been determined to be a slow-moving vehicle. Traffic monitor service 122 may determine the time period based on the speed of vehicle 160, e.g., an amount of time for the time period increasing as the speed of vehicle 160 decreases and the amount of time decreasing as the speed of vehicle 160 increases. At step 312, traffic monitor service 122 sets timer 124 for alerting other vehicles based on the determined time period. It should be noted that timer 124 may already be set because another slow-moving vehicle recently passed by traffic monitor 110. In such case, assuming the determined time period ends after a time period identified by timer 124 ends, traffic monitor service 122 resets timer 124 based on the determined time period, i.e., extends timer 124.

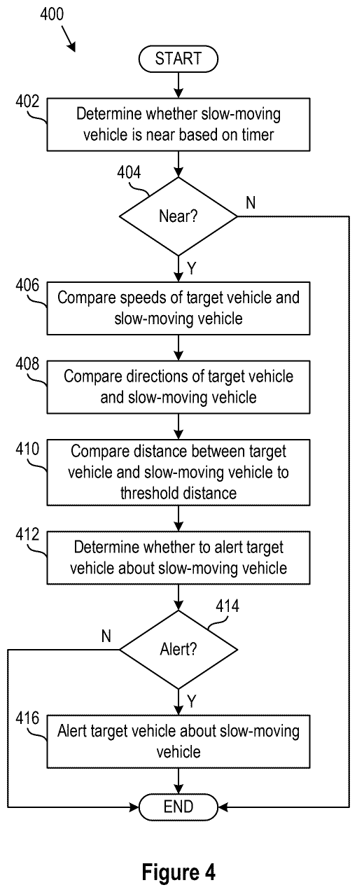

At step 314, traffic monitor service 122 may alert other vehicles about the slow-moving vehicle throughout the determined time period. Traffic monitor service 122 may alert the other vehicles, e.g., by instructing display device 150 to display a warning for the duration of the determined time period. The warning may include text indicating that the slow-moving vehicle is present and in front of other cars passing by traffic monitor 110. Additionally, the warning may include context such as the speed of the slow-moving vehicle, which traffic monitor service 122 may read from warning information 126. Traffic monitor service 122 may transmit such text and contextual information to display device 150 to cause display device 150 to display the warning. On the other hand, instead of immediately posting an alert, traffic monitor service 122 may wait until it detects other vehicles and then determine whether to warn them, as discussed below in conjunction with FIG. 4.

It should be noted that, according to some embodiments, traffic monitor service 122 may alternatively or additionally alert other vehicles according to other mechanisms. For example, traffic monitor service 122 may activate an alarm of traffic monitor 110. In response, traffic monitor 110 may output an alarm sound from a speaker in traffic monitor 110 or connected to traffic monitor 110. For example, the speaker may be in display device 150, and traffic monitor 110 may instruct display device 150 to output the alarm sound. Such alarm sound may be designed to be loud enough to be heard by vehicles driving by traffic monitor 110 or display device 150, including, e.g., sharp and repetitive beeping sounds.

At step 316, traffic monitor service 122 may determine the direction of vehicle 160, e.g., east or west on an east-west road. For example, if the response from vehicle 160 is received at a plurality of antennas 140, traffic monitor service 122 may first calculate an angle of arrival (AoA) of the response, which is the angle at which the response arrived at traffic monitor 110. For example, traffic monitor service 122 may calculate the AoA based on phase differences in a CTE tone of the response detected at antennas 140 or based on time differences in the response arriving at antennas 140. Traffic monitor service 122 may then determine the direction of vehicle 160 based on the AoA.

As another example, if the response from vehicle 160 is only received at a single antenna 140, traffic monitor service 122 may first determine whether vehicle 160 is moving toward traffic monitor 110 or away from traffic monitor 110. For example, traffic monitor service 122 may determine this based on a Doppler shift of the response. Doppler shift is a change in the frequency or wavelength of a signal as it is received. As another example, traffic monitor service 122 may determine whether vehicle 160 is moving toward or away from traffic monitor 110 based on a change in received signal strength indicators (RSSIs).

RSSI is a metric that measures the strength of a signal being received from a wireless device, e.g., by communication device 138 of traffic monitor 110. For example, vehicle 160 may transmit multiple responses to traffic monitor service 122 in response to a request for speed information. For each response, communication device 138 may measure the RSSI, and based on how the RSSI changes between responses, traffic monitor service 122 may determine whether vehicle 160 is moving toward or away from traffic monitor 110. Traffic monitor service 122 may then determine the direction of vehicle 160 based on whether it is moving toward or away from traffic monitor 110.

At step 318, traffic monitor service 122 may store the direction of vehicle 160 in warning information 126. At step 320, traffic monitor service 122 may determine a distance between vehicle 160 and traffic monitor 110. For example, if a response from vehicle 160 includes a TSSI, traffic monitor service 122 may first compare the TSSI to an RSSI of the response measured by communication device 138. Traffic monitor service 122 may then determine the distance based on a difference between the RSSI and TSSI. At step 322, traffic monitor service 122 may store the distance in warning information 126. After step 322, method 300 ends.

It should be noted that traffic monitor service 122 may eliminate some steps of method 300 based on which information it uses for reducing risks of collisions. For example, as discussed below in conjunction with FIG. 4, traffic monitor service 122 may make decisions without considering directions, e.g., because traffic monitor service 122 is on the side of a one-way road. In such case, traffic monitor service 122 may skip steps 316 and 318. As another example, as discussed below in conjunction with FIG. 4, traffic monitor service 122 may make decisions without considering distances, and traffic monitor service 122 may skip steps 320 and 322.

FIG. 4 is a flow diagram of a method 400 that may be performed by traffic monitor 110 to alert target vehicles about slow-moving vehicles ahead based on information about the target vehicles and the slow-moving vehicles, according to some embodiments. Method 400 may be performed by traffic monitor 110 after analyzing information about a vehicle passing by according to method 300. As used with respect to method 400, a “target vehicle” is a vehicle that traffic monitor 110 is considering warning about a slow-moving vehicle. At step 402, traffic monitor service 122 determines whether a slow-moving vehicle is near based on timer 124. For example, if timer 124 is set to a nonzero value when traffic monitor service 122 receives a response from the target vehicle, traffic monitor service 122 may determine that a slow-moving vehicle is near. Otherwise, traffic monitor service 122 may determine that a slow-moving vehicle is not near.

At step 404, if a slow-moving vehicle is not near, method 400 ends, and traffic monitor service 122 determines not to alert the target vehicle. Otherwise, if a slow-moving vehicle is near, method 400 moves to step 406. Steps 406-410 include optional steps that traffic monitor service 122 may perform to determine whether to alert the target vehicle about the nearby slow-moving vehicle. For example, traffic monitor service 122 may perform each of steps 406-410, only a subset of steps 406-410, or none of steps 406-410.

At step 406, traffic monitor service 122 may compare the speeds of the target vehicle and slow-moving vehicle. Traffic monitor service 122 may read the speed of each vehicle from warning information 126. At step 408, traffic monitor service 122 may compare the directions of the target vehicle and slow-moving vehicle. Traffic monitor service 122 may read the direction of each vehicle from warning information 126.

At step 410, traffic monitor service 122 may compare the distance between the target vehicle and the slow-moving vehicle to a threshold distance. To determine the distance between the vehicles, traffic monitor service 122 may first read, from warning information 126, a first distance between the target vehicle and traffic monitor 110, a second distance between the slow-moving vehicle and traffic monitor 110, and AoAs of responses received from the target vehicle and slow-moving vehicle. Traffic monitor service 122 may then determine the distance between the vehicles using triangulation, based on the first and second distances and based on the AoAs.

At step 412, traffic monitor service 122 determines whether to alert the target vehicle about the slow-moving vehicle. For example, traffic monitor service 122 may determine to alert the target vehicle based only on results of step 402, e.g., based on the speed of the slow-moving vehicle being less than the threshold speed and based on traffic monitor 110 receiving a response from the target vehicle before a time period for warning about the slow-moving vehicle ends. Traffic monitor service 122 may further make this determination based on results of step 406, e.g., determining to alert the target vehicle in response to its speed being greater than that of the slow-moving vehicle. Traffic monitor service 122 may further make this determination based on results of step 408, e.g., determining to alert the target vehicle in response to it moving in the same direction as the slow-moving vehicle. Traffic monitor service 122 may further make this determination based on results of step 410, e.g., determining to alert the target vehicle in response to it being less than a threshold distance from the slow-moving vehicle.

At step 414, if traffic monitor service 122 determines not to alert the target vehicle, method 400 ends. Otherwise, if traffic monitor service 122 determines to alert the target vehicle, method 400 moves to step 416. At step 416, traffic monitor service 122 alerts the target vehicle about the slow-moving vehicle, e.g., by instructing display device 150 to display a warning, e.g., for a few seconds so that the warning is viewable at the target vehicle as the target vehicle passes by display device 150. The warning may include text indicating that the slow-moving vehicle is in front of the target vehicle. Additionally, the warning may include context such as the speed of the slow-moving vehicle and the distance between the target vehicle and the slow-moving vehicle. Traffic monitor service 122 may transmit such text and contextual information to display device 150 to cause display device 150 to display the warning. After step 416, method 400 ends.

It should be noted that, according to some embodiments, traffic monitor service 122 may alternatively or additionally alert the target vehicle according to other mechanisms. For example, as discussed above in conjunction with FIG. 3, traffic monitor service 122 may activate an alarm of traffic monitor 110, and traffic monitor 110 may output an alarm sound in response. As another example, traffic monitor service 122 may transmit a BLE signal to the target vehicle including data that indicates that the slow-moving vehicle is in front of the target vehicle. Such BLE signal may cause the target vehicle to display the alert, e.g., on a display screen of an infotainment system of the target vehicle.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

What is claimed is:

1. A traffic monitor including a processor and memory, wherein the processor executes instructions stored in the memory to alert a second vehicle about a first vehicle in front of the second vehicle, by performing the following steps:
broadcasting a first request for speed information as a first Bluetooth Low Energy (BLE) signal, the first request including a universally unique identifier (UUID) associated with BLE and associated with a service of the traffic monitor, and then receiving a first response from the first vehicle in response to the first request, the first response containing data that indicates that the first vehicle is moving at a first speed;
comparing the first speed to a threshold speed to determine that the first speed is less than the threshold speed, and determining, based on the first speed, a first time period for alerting other vehicles about the first vehicle; and
alerting the second vehicle during the first time period about the first vehicle in response to the first speed being less than the threshold speed.

2. The traffic monitor of claim 1, wherein the steps further include:
extracting the data from the first response to determine the first speed, the first speed being a speed measured by the first vehicle and reported by the first vehicle in the first response.

3. The traffic monitor of claim 1, where alerting the second vehicle about the first vehicle includes:
performing at least one of: (1) displaying, on a display device, text indicating that the first vehicle is in front of the second vehicle, (2) transmitting a second BLE signal to the second vehicle including data that indicates that the first vehicle is in front of the second vehicle, and (3) outputting an alarm sound from a speaker in the traffic monitor or connected to the traffic monitor.

4. The traffic monitor of claim 1, wherein the steps further include:
broadcasting a second request for speed information as a second BLE signal, the second request also including the UUID, and then receiving a second response from the second vehicle in response to the second request, the second response containing data that indicates that the second vehicle is moving at a second speed.

5. The traffic monitor of claim 4, wherein the steps further include:
alerting the second vehicle about the first vehicle in response to the second response being received by the traffic monitor before the first time period ending.

6. The traffic monitor of claim 4, wherein the steps further include:
comparing the first speed to the second speed to determine that the second speed is greater than the first speed; and
alerting the second vehicle about the first vehicle in response to the second speed being greater than the first speed.

7. The traffic monitor of claim 4, wherein the steps further include:
comparing the second speed to the threshold speed to determine that the second speed is also less than the threshold speed, and determining, based on the second speed, a second time period for alerting other vehicles about the second vehicle; and
resetting, before the first time period ends, a timer for alerting other vehicles, based on the second time period.

8. The traffic monitor of claim 4, wherein the steps further include:
determining, based on the first response, that the first vehicle is moving in a first direction, and determining, based on the second response, that the second vehicle is also moving in the first direction; and
alerting the second vehicle about the first vehicle in response to the first and second vehicles both moving in the first direction.

9. The traffic monitor of claim 8, wherein the traffic monitor includes a plurality of antennas, and the steps further include:
calculating an angle of arrival (AoA) of the first response based on one of (1) phase differences in a constant tone extension (CTE) detected at the antennas from the first response and (2) time differences in the first response arriving at the antennas; and
determining that the first vehicle is moving in the first direction based on the calculated AoA.

10. The traffic monitor of claim 8, wherein the steps further include:
determining that the first vehicle is moving toward the traffic monitor or that the first vehicle is moving away from the traffic monitor, based on one of (1) a Doppler shift based on the first response and (2) a change in received signal strength indicators (RSSIs) between the first response and a third response received from the first vehicle; and
determining that the first vehicle is moving in the first direction based on the first vehicle moving toward the traffic monitor or based on the first vehicle moving away from the traffic monitor.

11. The traffic monitor of claim 4, wherein the steps further include:
determining, based on the first and second responses, a distance between the first vehicle and the second vehicle; and
alerting the second vehicle about the first vehicle in response to the distance between the first and second vehicles being less than a threshold distance.

12. The traffic monitor of claim 11, wherein the first response includes a first transmitter signal strength indicator (TSSI), the second response includes a second TSSI, and the steps further include:
measuring a first received signal strength indicator (RSSI) based on a strength of the first response when received at the traffic monitor, and measuring a second RSSI based on a strength of the second response when received at the traffic monitor;
comparing the first RSSI to the first TSSI, and comparing the second RSSI to the second TSSI;
determining a first distance between the first vehicle and the traffic monitor based on a difference between the first RSSI and the first TSSI, and determining a second distance between second vehicle and the traffic monitor based on a difference between the second RSSI and the second TSSI; and
determining the distance between the first and second vehicles based on the first and second distances.

13. A method of alerting a second vehicle about a first vehicle in front of the second vehicle, the method comprising:
broadcasting a first request for speed information as a first Bluetooth Low Energy (BLE) signal, wherein the first request includes a universally unique identifier (UUID) associated with BLE and associated with a service of the traffic monitor, and then receiving a first response from the first vehicle in response to the first request, wherein the first response contains data that indicates that the first vehicle is moving at a first speed;
comparing the first speed to a threshold speed to determine that the first speed is less than the threshold speed, and determining, based on the first speed, a first time period for alerting other vehicles about the first vehicle; and
alerting the second vehicle during the first time period about the first vehicle in response to the first speed being less than the threshold speed.

14. The method of claim 13, further comprising:
broadcasting a second request for speed information as a second BLE signal, the second request also including the UUID, and then receiving a second response from the second vehicle in response to the second request, the second response containing data that indicates that the second vehicle is moving at a second speed.

15. The method of claim 14, further comprising:
alerting the second vehicle about the first vehicle in response to the second response being received by the traffic monitor before the first time period ending.

16. The method of claim 14, further comprising:
comparing the first speed to the second speed to determine that the second speed is greater than the first speed; and
alerting the second vehicle about the first vehicle in response to the second speed being greater than the first speed.

17. The method of claim 14, further comprising:
comparing the second speed to the threshold speed to determine that the second speed is also less than the threshold speed, and determining, based on the second speed, a second time period for alerting other vehicles about the second vehicle; and
resetting, before the first time period ends, a timer for alerting other vehicles, based on the second time period.

18. A non-transitory, computer-readable medium comprising instructions that are executable in a traffic monitor, wherein the instructions when executed cause the traffic monitor to carry out a method of alerting a second vehicle about a first vehicle in front of the second vehicle, and wherein the method comprises:
broadcasting a first request for speed information as a first Bluetooth Low Energy (BLE) signal, the first request including a universally unique identifier (UUID) associated with BLE and associated with a service of the traffic monitor, and then receiving a first response from the first vehicle in response to the first request, the first response containing data that indicates that the first vehicle is moving at a first speed;
comparing the first speed to a threshold speed to determine that the first speed is less than the threshold speed, and determining, based on the first speed, a first time period for alerting other vehicles about the first vehicle; and
alerting the second vehicle during the first time period about the first vehicle in response to the first speed being less than the threshold speed.

19. The non-transitory, computer-readable medium of claim 18, wherein the method further comprises:
extracting the data from the first response to determine the first speed, the first speed being a speed measured by the first vehicle and reported by the first vehicle in the first response.

20. The non-transitory, computer-readable medium of claim 18, where alerting the second vehicle about the first vehicle includes:
performing at least one of: (1) displaying, on a display device, text indicating that the first vehicle is in front of the second vehicle, (2) transmitting a second BLE signal to the second vehicle including data that indicates that the first vehicle is in front of the second vehicle, and (3) outputting an alarm sound from a speaker in the traffic monitor or connected to the traffic monitor.
